(19) United States
(12) Patent Application Publication
(10) Pub. No.: US 2013/0343826 A1
(43) Pub. Date: Dec. 26, 2013

(54) CUTTING TOOL INSERT WITH POWDER METAL INSERT BODY

(71) Applicant: Steven Webb, Houston, TX (US)

(72) Inventor: Steven Webb, Houston, TX (US)

(21) Appl. No.: 13/532,002

(22) Filed: Jun. 25, 2012

(51) Int. Cl. B23B 27/14

(52) U.S. Cl. CPC B23B 27/148
USPC 407/118; 264/682

(57) ABSTRACT

A method of making a cutting tool insert, including positioning and fixing an abrasive tip in a mold, filling the mold with a powder metal mixture, and infiltrating the powder metal mixture around at least a portion of the tip to define a green body. The method further includes compacting the powder metal to define a pressed green body, sintering the pressed green body to yield a sintered body having a metallic portion and a tip portion, and cooling the sintered body to put the tip portion into compression. The tip portion is non-adhesively mechanically attached to the metallic portion.

### TECHNICAL FIELD

The article description set forth herein relates generally to cutting tool inserts, and, more particularly to tipped cutting tool inserts having metal bodies formed from powder metal precursors with tips partially embedded therein.

### BACKGROUND

Machining, cutting, sawing and/or drilling tools are often provided with removable inserts A including durable insert bodies with attached cutting surfaces or tips composed of hard materials, such as cemented carbides and ceramics. These inserts A are a disposable part of the machine cutting tool system (see FIG. 1). Typically, insert A is firmly wedged into a tool-holding device B and imposed into moving contact with a moving metallic work piece C (see FIG. 2). The kinematics of the hard insert cutting edge contacting the metallic work piece C results in cutting, generating metal chips which are conveyed away by the insert A.

As shown schematically in FIG. 3, a typical prior art insert A contacts and cuts the hard workpiece B with its edge, while the insert surface directs the cuttings or chips (rake) away from the tool and work piece B as waste. The chip material is deflected and/or bent so as to break or otherwise safely be carried away from the work piece B and/or tool-holding system for later disposal. The portion of the insert A that contains the rake and flank surfaces is called the tip portion D. Very little of the insert A surface contacts the work piece B. Only the tip D is directly involved in contacting the work piece to engage in cutting. The balance of the insert volume, the body portion E, is a durable material that supports and stiffens, or holds rigid, the tip portion D against deflection under the cutting shear and tensile/bend forces. The body E also helps conduct friction heat away from the flank or contact surface. The body E thus does not perform the same function as the tip D, and thus its desired physical properties are different. The body E need not be made of the same hard material as the flank and rake; it need not even be made of a hard material. The body E is typically sufficiently stiff so as to resist bending, and is also typically sufficiently thermally conductive so as to remove friction heat to help cool the cutting edge D. The fact that many inserts A are made of a single hard material “solid” is merely a convenience of manufacture that from which the end user does not necessarily benefit.

The tip D is typically a piece of superabrasive, ceramic and/or carbide (such as tungsten carbide) or alternative cutting material mechanically bonded, brazed, soldered, or welded into position on a durable support body E to define an Insert A. Inserts A are intended to be discarded when worn out, and then replaced with fresh inserts A. The insert A may comprise a single hard material or a composite of two hard materials defining the tip portion D and the body portion E. This configuration is typically called a ‘tipped insert’. In a tipped insert, the tip D and body E portions are produced separately and are then placed in contact and bonded together by such methods as welding, brazing, press-fit, thermal shrink-fit or diffusion-bonding, based on mechanical or chemical/adhesive forces, and may be reversible or irreversible. The tip D is restricted to shapes that are compatible with the bonding process. Typically adhesive bonding, such as brazing and gluing, requires simple flat surfaces to allow adhesive to flow and fill properly. Mechanical bonding, such as press-fit, benefits from interlocking key-in-lock shapes derived from high-precision forming of tip D and body E.

Eventually the sharp edge, flank or rake surfaces within the tip D overheat, wear excessively and damage the work piece B, or break away in chips, or shatter and break loose from body E. The insert A is then removed, rotated, flipped or entirely replaced, to impose a fresh unused tip D and edge to continue the cutting process. In the tipped insert configuration, there is the additional possibility of the tip portion D disengaging from the body portion E as the adhesion between the tip and body portions D, E is degraded by the thermal and mechanical forces developed at the work piece interface.

Thus, there is a need for an improved cutting tool insert system. The present novel technology addresses this need.

### BRIEF DESCRIPTION OF THE DRAWINGS

FIG. 1 is a view of a prior art solid insert.

FIG. 2 is view of a prior art solid insert cutting metal.

FIG. 3 is diagram showing how metal is cut and chips conveyed away by a prior art insert, the insert is this case having a tip.

FIG. 4 is a perspective view of a cutting tool insert according to a first embodiment of the present novel technology.

FIG. 5 is a perspective view of a first cutting tip as incorporated into FIG. 4.

FIG. 6 is a perspective view of a second, notched cutting tip as incorporated into FIG. 4.

FIG. 7 is a partial cross-section cutaway view of the embodiment of FIG. 4.

FIG. 8 is an enlarged view of a section of FIG. 7.

FIG. 9A is a perspective view of a mold for producing FIG. 4.

FIG. 9B is a perspective view of the mold of FIG. 9A being filled with powder metal.

FIG. 9C is an enlarged view of the powder metal of FIG. 9B.

FIG. 9D is a perspective view of the mold of FIG. 9A as filled with powder metal and a tip.

FIG. 10 is a process diagram of a first method of producing FIG. 4.

FIG. 11 is a a process diagram of a second method of producing FIG. 4.

FIG. 12 is a process diagram of a third method of producing FIG. 4.

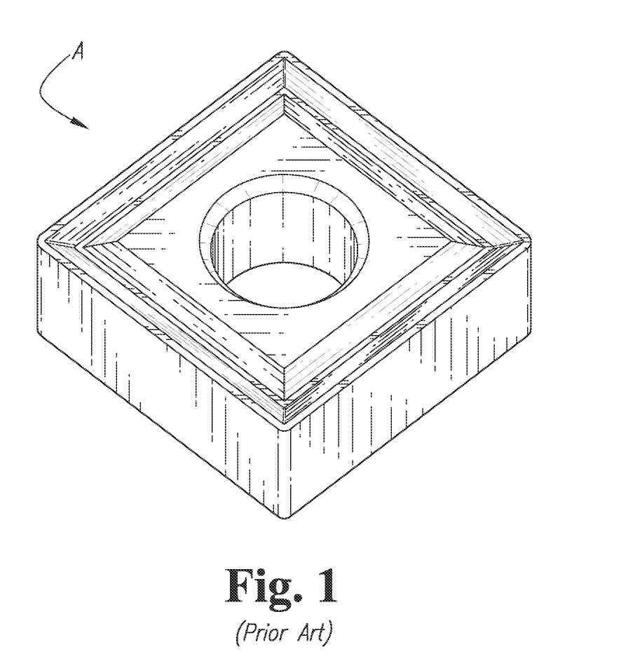

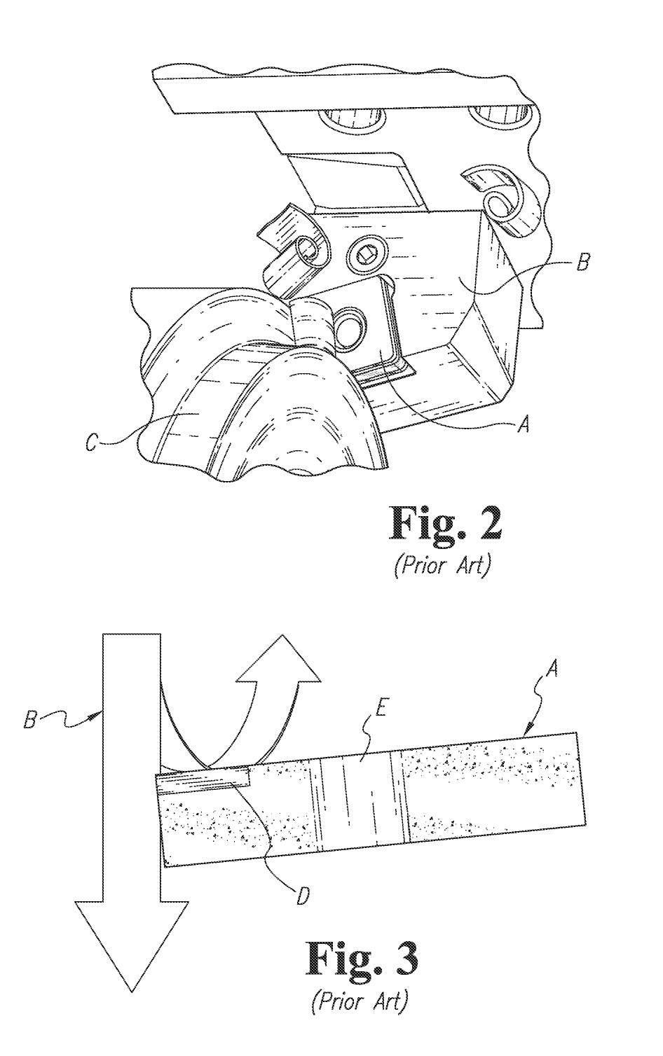

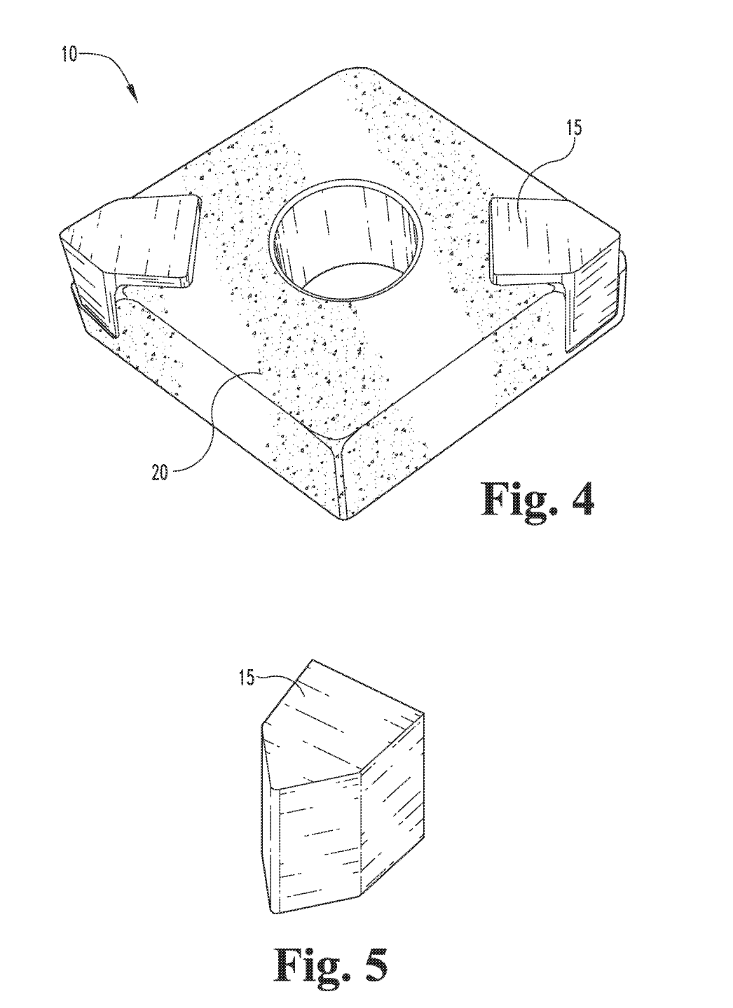

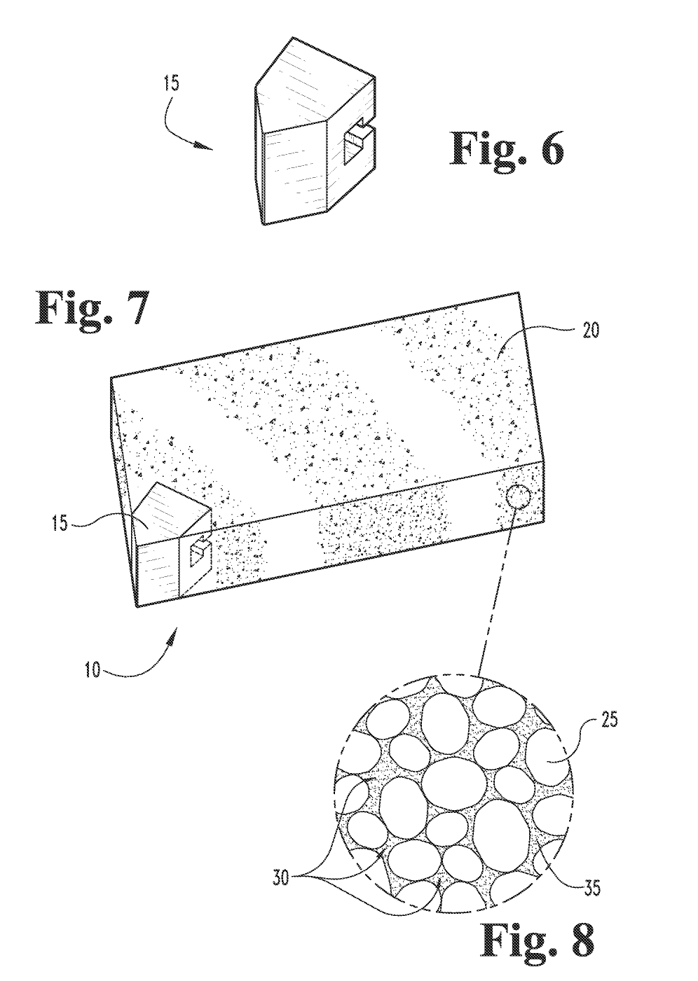

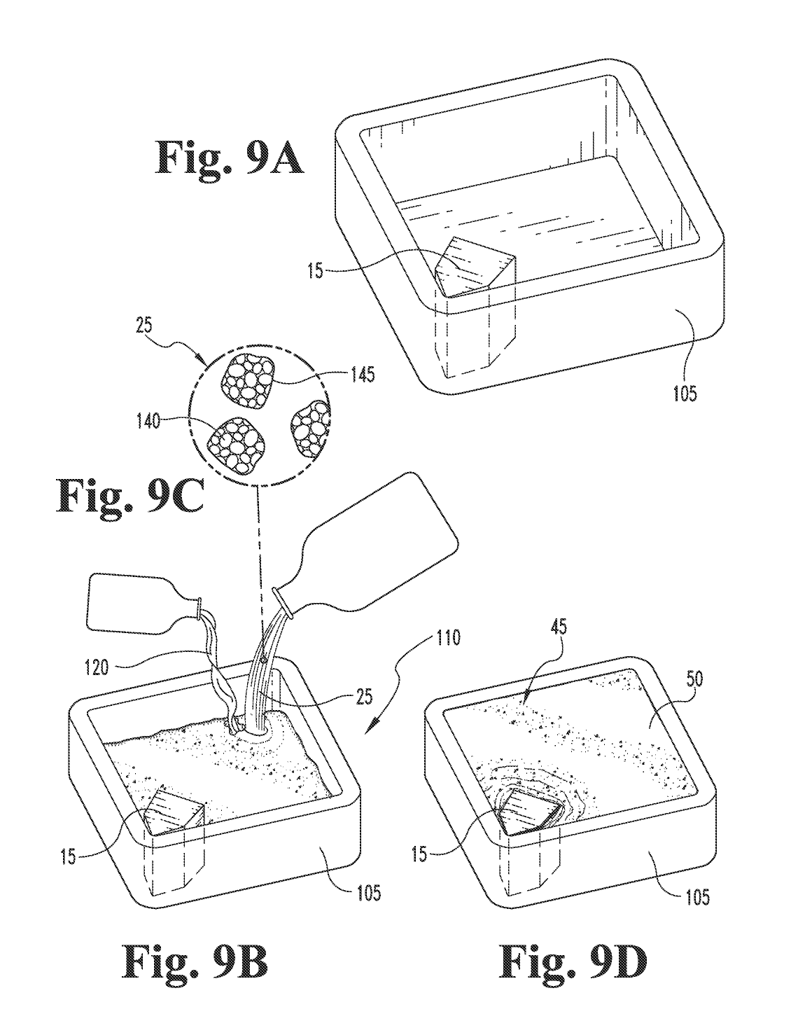

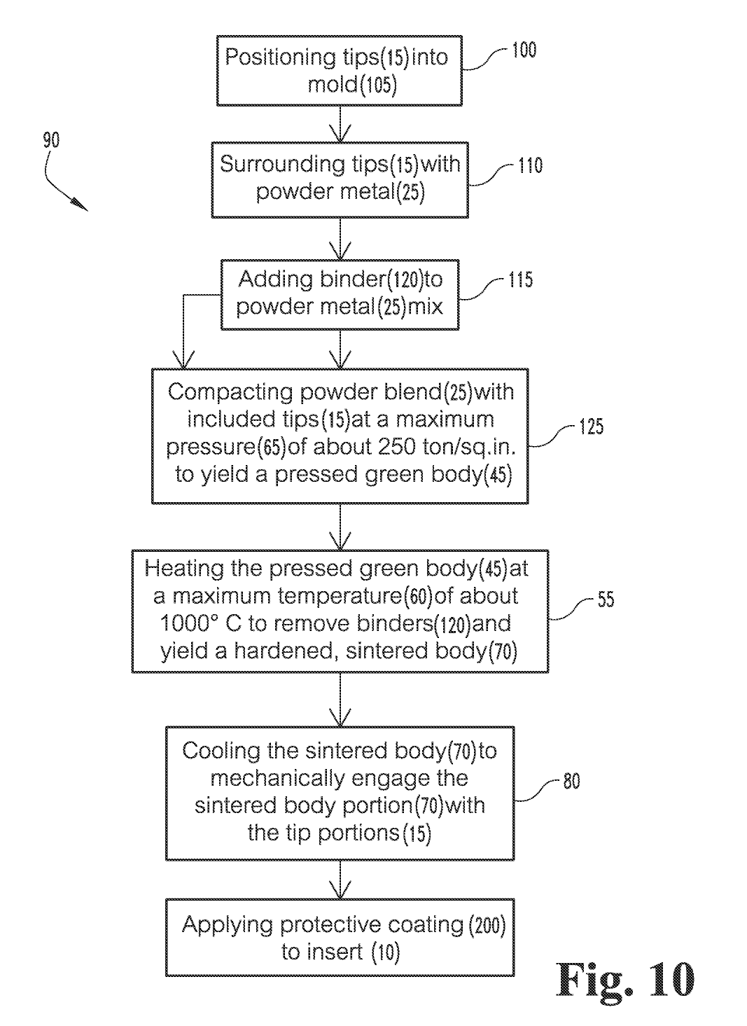

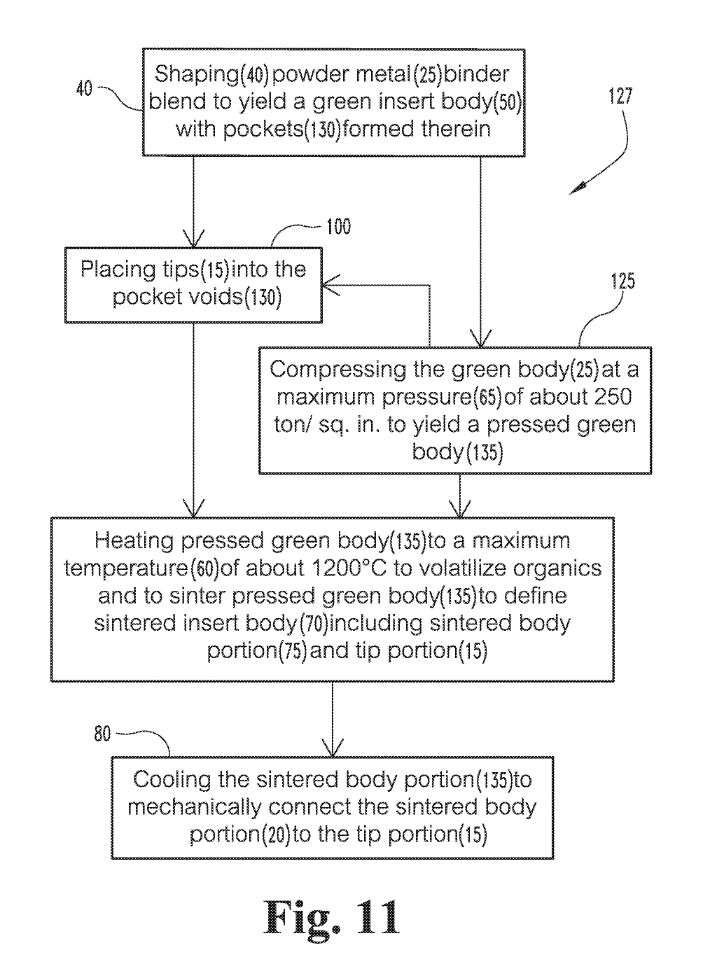

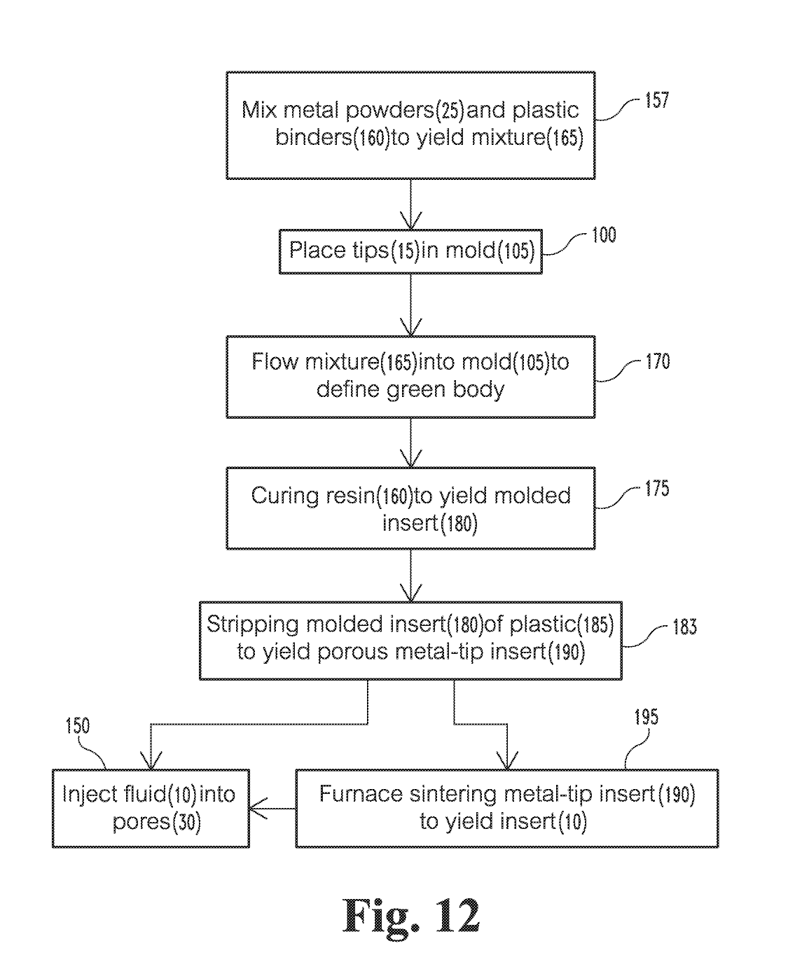

### DETAILED DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

The cutting tool insert 10 of the present novel technology includes one or more tips 15 attached to a body 20. The tip 15 is typically formed from a refractory material and, more typically, is hard and/or non-deformable. The tip 15 may be sharpened or blunted, and likewise may be shaped by various methods convenient for hard material shaping. The insert body 20 is formed from sintered powdered metal 25, metal blends or alloys, typically either blended as powder or pre-alloyed. The powder metal precursor 25 typically includes powdered steel, iron, aluminum, zinc, magnesium, and combinations thereof, and may alternately include various other powders, metallic or non-metallic, including graphite, carbon, sulphides, organic or inorganic lubricants, and/or rust preventatives and the like. The insert body 20 is typically porous, with either open or closed porosity. The pores 30 may be empty or filled, such as with lubricant or cooling fluids 35.

The insert body 20 is typically formed from a powdered steel precursor material 25 and may be cold pressed, hot pressed, or the like 40 to form an uncured composite insert 45 comprising one or more tips 15 and a green insert body portion 50 at least partially surrounding or enclosing some portion of the tips 15. The uncured composite insert body 45, containing the tips 15, is then hardened or cured 55 with each respective tip 15 in contact with, encased by and/or enclosed by the powdered metal green body portion 50. The uncured insert body portion 50 may be molded into any shape, typically to improve tolerance of the subsequently cured part, under pressure (typically less than 250 ton/in²) (a process typically referred to as “coining” or “repressing”) and/or shaped by any soft machining method, prior to hardening 55. The shaped uncured insert composite body 45, containing one or more tips 15, is then sintered and hardened 55 at sufficient temperature 60 (typically up to about 1,200° C.) and sufficient pressure 65 (typically less than 250 ton/in²) to yield a cured composite body 70 having a tip portion 15 and a cured body portion 75. In the process of curing 55, the green shaped insert body 50 shrinks around the tips 15 to encase or envelope some portion of each respective tip 15 in at least one direction. In the process of cooling 80, the shrunken hardened steel body portion 75 is typically in contact with at least 10% of the area of each respective tip 15, and the hard steel body portion 75 puts each of the tips 15 into compression, thus providing mechanical attachment and grip strength. The curing or sintering process 55 enjoys temperature and pressure 60, 65 combinations that are insufficient to form adhesive bonds between the tip 15 and body 20 portions.

The insert body 10 may have a specific geometrical arrangement with each included tip 15 to improve grip within the cured metal body matrix 75, as well as to eliminate gaps, distortion and excess strain in the cured body portion 75. Such tip geometry may include “pine-tree” shapes, re-entrant angles and like features that improve mechanical grip. Indeed, one specific advantage of the instant technology compared to prior press-fit or thermal shrink-fit techniques is that the tip 15 need not be precision machined. Almost any rough surface, or shape that allows green metal powder to flow within will work.

The tips 15 are typically formed from a material that generally will not crack, distort, soften, and/or chip during the curing process 55 to yield a durable composite insert body 20. Each tip 15 may be ground to remove asperities or used as-fired, without any machining operation, or as-cut by any conventional cutting method, including EDM, laser, saw or the like. Each tip 15 may have exposed cutting edges, flank surfaces and/or rake surfaces if to be used in cutting as-fired. In this case, edge geometry features such as radius, angles, chamfers, hones and the like are typically provided in the tips 15 prior to placing in contact with powdered steel 25. Alternately, the inserts 10 containing tips 15 may be machined via conventional methods to expose edge, flank and rake surfaces. In this case, geometric details can be created in the tips 15 by machining the entire insert 10 or only the tips 15.

A method 90 of forming the novel cutting tool insert 10 is described. The method includes providing tips 15 of required dimension and shape, placing 100 tips 15 in a mold 105, partially or completely surrounding 110 tips 15 with powder metal 25 such as by filling mold 105 with powdered metal blend 25 to infiltrate or flow metal around tips 15 and, typically, adding 115 a small amount of wax or binding agents 120, and compacting 125 the powder blend 25 with the included tips 15 to yield a “green” body 45 or assembly. The tips 15 are typically strong enough to withstand compacting, typically less than 250 ton/in², without damaging themselves and/or the press tooling.

The tips 15 are adhered to the green body portion 50 by the wax/binder additives 120 in the powdered metal blend 25 and may be handled normally. The green assembly 45, defining one or more tips 15 embedded in a relatively soft body portion 50 formed of pressed powdered metal 25, is then heated 55 to about 1000° C. by any variety of conventional methods, typically at a sufficiently slow ramp rate to yield removal of the binder and/or organic materials 120 without damaging the green body 50, as well as to sinter together the metal powder particles 25. Sintering 55 shrinks the green body 50 around the tips 15, putting the tips 15 into compression while hardening the insert body portion 75. The tips 15 are thus mechanically held in the hardened, solidified insert body portion 75 that has been formed around them, and in some cases intertwined and/or entangled with the tips 15.

In another embodiment 127, a method of forming the novel cutting insert is described. The method includes shaping 40 a predetermined amount of powder metal 25, typically along with a smaller predetermined amount of binder 120, into a green insert body 50 having pockets or shelves or void volumes 130 formed therein. One or more tips 15 are placed 100 in the green insert body coincident with the void volumes. The tips 15 may be placed 100 into the powder metal insert body portion 50, either before or after mild compressive forces are applied 125, to define a green-pressed insert body 135. The tips 15 may be temporarily attached to the green-pressed insert body 135 via adhesive to allow normal handling and conveyance. The assembly 135 is then heated 55 to up to about 1200° C., causing the green body 135 to sinter and shrink into contact with and mechanically bind the included tips 15 and any adhesive to volatilize off. Typically, the shrinkage of the sintering green insert body 135 is sufficient to engender complete and conformal contact between the sintered insert body portion 75 and the included tips 15, yielding a cured composite insert body 70 wherein the tips are mechanically connected.

The hot tips 15 and hot sinter-hardened metal-based body portion 25 in mechanical contact with the tips 15 both thermally contract upon cooling 80. The tip 15 material typically has a lower coefficient of thermal expansion than does the insert body material, and thus the tips 15 contract less than the body 20, putting the tips 15 into compression. The grip strength of the metal insert body 20 holding the tips 15 is defined, at least in part, by the elastic modulus of the body material, contact area, and the differential of the coefficients of expansion of the tip 15 and of the body 20. Conformal and uniform contact helps to minimize point-loading compression effects on the tip 15 that may cause the tip 15 or cured powdered metal body 20 to crack. As the tips 15 are put into compression, the insert body 20 is likewise put into tension. The body 20 typically has sufficiently high tensile strength to withstand this tension without cracking.

This method of mechanical connection of the tips 15 to the body 20 differs from conventional thermal shrink-fit in that the body material is formed in-situ within the same thermal cycle as the shrink-fit. The insert body 20 is not preformed in a separate process, as is the case with conventional attachment methods. Further the tips 15 are not bonded to the insert body 20 by adhesion forces as they are in conventional tipped insert preparation techniques.

The tips 15 are typically prepared via conventional sintering techniques well known in the art. A tip 15 may be formed from any material convenient for machining, cutting, or drilling applications, including but not limited to carbides, ceramics or superabrasive such as silicon nitride, silicon carbide, boron carbide, titanium carbide-alumina ceramics such as titanium carbide, fused aluminum, tantalum carbide, cerium oxide, garnet, cemented carbides (e.g. WC—Co), synthetic and natural diamond, zirconium oxide, cubic boron nitride, laminates of these materials, composite materials, combinations thereof, and the like. These materials may be in the form of a single crystal, sintered polycrystalline bodies, or the like.

Generally, a tip 15 is harder than the desired workpiece and in the case of a tipped insert 10, harder than the insert body 20. A tip 15 should typically be able to withstand powdered metal forming pressures 65 of up to about 250 ton/in² or more, and likewise should be able to withstand sintering temperatures 60 of up to about 1100° C. or more, as applied separately or simultaneously, without experiencing irreversible distortion, hardness or toughness diminution, cracking, chipping and/or chemical reactions that result in softer phases.

A tip 15 may be formed into a desired shape via means of an abrasive water jet, EDM, saw, laser cut, grinding, or the like, and may alternately be formed to shape during sintering without any machining. A tip 15 is typically dimensioned to fit into the insert body 20 such that metal encloses the tip 15 in at least one dimension, with sufficient contact to grip the tip 15 well enough to support it during exposure to the anticipated forces during use. The tip 15 may be positioned within the insert body 20 such that there is sufficient tip area exposed to cut metal with acceptable flank wear and sufficient rake area to remove chip, without exposure of the insert body material to workpiece material. Any number of geometrical features may be added to the tip 15 to improve attachment. In particular, the tip 15 may include apertures or channels or the like into and through which powder metal 25 may flow during formation, but which would otherwise be impossible to engage with a solid, preformed insert body, so as to threadedly or intertwinedly engage the insert body portion 20 once it has been hardened. The powder metal body generation process as detailed above automatically ensures that like mating geometrical features are added to the body 20 to be compatible included tips 15, and additional geometric features may be included to make the insert body 20 likewise compatible with various tool-holding methods and fixtures, including holes, tapers, chamfers, angles and radii.

Any powder metal blend 25 may be chosen that conforms to the tips 15 at forming pressure 65 and sintering temperatures 60, as discussed above. The powder metal blend 25 may contain fluids, fluxes or additives to improve sintering or improve mechanical gripping of the tips 15.

Typically, the tips 15 are added to the mold 105 and positioned and fixed as desired. Tips are held well enough within the mold, such as by alignment pins, springs, wedges or the like, to resist dislocation (rotation, tilting, translation and the like) by powder metal flow. The powdered metal blend 25 then fills 110 the mold 105 around the tips 15 to form the shape of the cutting tool insert 10. The powder metal volume 25 typically conforms, wets and/or contacts the included tips 15 that make up the cutting tool insert 10. The tips 15 are held in place within the mold 105. The powder metal 25 is typically flowed 110 into the mold 105 under pressure, which typically improves the packing of the mold 105 and speeds up mold filling. The powder metal conforms to the shape of the tips 15 fixed in the mold.

The particle size 140 of the powdered metal 25 is typically between about 2 and about 200 microns. The granule size 145 of powdered metal 25 may be from 50 to 1000 microns. The powdered metal 25 may be gas-atomized or water-atomized. Virtually any powdered metal blend 25, including any compound or element, metallic or non-metallic, organic or inorganic, magnetic, paramagnetic or diamagnetic, known to the art can be used as an insert body, although typically the powder 25 is metallic and more typically yields a hard, metallic insert body.

One advantage of molding inserts via powdered metal molding is that dimensional precision to form a bond between the body 20 and tip 15, normally required for brazing and/or press fit attachment of a pre-manufactured, solid (non-flowable) insert body is no longer required. The tips 15 may be formed via faster, less precise cutting or forming means. The powdered metal 25 is typically flowable and the volume of powder metal filling the insert body mold 105 will change shape and conform into contact the tips 15 during green pressing 125 and/or during firing 55.

Another advantage of the present novel technology arises from the way that the tips 15 may be formed to enjoy complex shape features, such as fins, teeth, sharp corners, as such complex features typically impair brazing and/or give rise to breaking the cutting edge during mechanical bonding. Conversely, in the present novel technology, such complex shape features actually improve mechanical attachment of the tip 15 to the insert body 20.

Another advantage enjoyed by the instant novel technology is that flowable, moldable, cured powdered steel 25 is much easier to grind than soft dense steel, hard dense steel or hard carbide, which are the conventional body materials for tipped cutting tools. This means that fine features, such as chip breakers, cooling channels, and the like, may be included in the insert body 20 during formation or later added during insert grinding without prematurely dulling the grinding wheel. Furthermore, since powdered metal parts are porous, fluids or waxes 35 may be left in, or infiltrated 150 after cure, such as to tailor machinability of the novel insert 10.

Any conventional mold 105, such as a steel mold, may be utilized for forming the insert 10. The mold 105 may be of any desired shape of the cutting insert 10. Typically, the mold 105 will be near-net, meaning the size of the cured insert 70 will be close to the final insert size. Additionally, the mold 105 may vary in shape, size or thickness and may correspond to the desired cutting tool holder shape or size. The mold 105 may accept a single tip 15 or a plurality of tips 15, or any size or shape, compatible with the mold size and geometry.

In one embodiment, a tip 15 may initially be placed in the mold 105 and then the powdered metal 25 introduced into the mold 105. The mold 105 may then be either heated, cold pressed, or both, simultaneously or concurrently, to form the cured insert 70. The powdered metal 25 may be preheated, heated in conveyance or simply heated in the mold 105 by any known means, or left unheated. Similarly the tip 15 may be used cold or hot.

The pressed steel/tip composite 135 is removed from the mold 105 and then fired 55 by conventional batch or tunnel furnaces or microwave or any other thermal method known to the art. One or more new tips 15 are placed into the mold 105 and the process repeated. Automation may be added to facilitate tip placement in the mold 105, as part of the pressing cycle.

In alternate embodiments, the insert 10 may be made using metal-resin molding 155 such as metal injection molding. Metal injection molding includes mixing 157 fine metal powders 25 with plastic binders 160 to render the metal powder more flowable. Tips 15 are placed 100 in the mold 105 as usual, and metal/resin/binder compound 165 is injected 170, typically under heat and pressure into the mold 105 around the tip 15. After curing 175, which entails hardening, cooling and/or shrink of the resin, the molded insert 180 is then stripped 183 of plastic 185, such as via solvent extraction or vaporization, leaving a porous green metal-tip insert 190. This body 180 is then furnace sintered 195 to form a dense, hard insert 10. This is method is intrinsically more expensive than fabrication from conventional dry powder metal 25, but is more suited for production of complex insert body shapes.

The molded cutting tool insert 10 may be finish ground, polished, or otherwise further processed to remove irregularities, asperities, and the like, in its shape to aid in fit within the cutting tool holder. The finish grinding or shaping of the insert body 10 may be carried out using any of the processes including but not limited to Wire Electro Discharge Machining (WEDM), milling, PM sintering, sintering and forging, forging, stamping, casting, and molding. For example, the insert body 10 may be ground to a variety of shapes including hones, chamfers, wipers (multiple cutting nose radii), rake angles, clearance angles, and the like known to the art without limit. In another embodiment of the novel technology, the cutting tool insert body 10 may include chip-breaking patterns, alignment holes, or chamfers within or on its body 10. Additionally, an electroless nickel chromium hard coat 200, or subsequent PVD or CVD ceramic hard coating may be applied to the insert body 10 to protect the insert. Any conventional metal part coating or machining method may be used on the powdered metal insert 10.

Further processing of porous steel insert body 10 may include infiltration 150 of rust-preventing fluid, lubricant fluids 35 (to improve grinding), steaming (pressurized) or oxidation to improve corrosion resistance, color and grindability.

Finally, the tip 15 will conventionally comprise a single hard material. However, it may also comprise a single-layer of hard material or many layers of different materials, such as metal or ceramic layers, themselves bonded to the hard material. These layers may function as thermal insulators, space filling (such as to reduce hard diamond cost), and anti-friction or braze layers.

Inserts 10 of any variety of shape, size, or thickness, attachable to a wide variety of cutting tool holders for use in turning, milling, boring, sawing, and drilling applications may be created. The insert 10 of the present novel technology may contain multiple tips 15 and does not require external clamps, body wedges, or fixture constraints. Tips 15 may be the same material or different material, and different tip sizes and shapes within the same insert 10 are possible.

The following examples are merely representative of the work that contributes to the teaching of the present novel technology, and the novel technology is not to be restricted by the examples that follow.

### Example-1

A ceramic tip 15 of dimensions 0.192″×0.140″×0.11″ with an 80° tip angle was placed into a slot in a conventional Fe-carbon powder green body 50, and pressed 125 at 80 ton/in² to define an assembly 45. The assembly 45 was fired 55 at 1050° C. in oxygen-deficient atmosphere for 3 hours. The ceramic tip 15 was strongly attached even though there were significant gaps between tip 15 and sintered steel 75. The bonded tips 15 survived EDM cutting and grinding without movement or cracking.

### Example-2

A ceramic tip 15 prepared as described above in Example-1 was placed in the corner of a steel mold 105 intended to make a 0.50″×0.25″×1″ long rectangular bar. The tip 15 was buried 100 with the same Fe-carbon powder 25, green-pressed at 80 ton/in², and fired 55 as in Example-1. The green assembly 45 was held together via adhesion with wax 120 in the powdered metal blend 135. The green-pressed body 135 was then sintered 55 to yield an insert 10. The ceramic tip 15 was conformal, gap-free and strongly mechanically gripped to the body 20. It survived EDM cutting and grinding without movement or cracking.

It will be appreciated that several of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A cutting tool insert, comprising:
a sintered powder metal insert body; and
an abrasive tip partially embedded in the insert body;
wherein the tip is nonadhesively mechanically connected to the insert body.

2. The cutting tool insert according to claim 1, wherein the sintered powder metal body is selected from the group including iron, magnesium, aluminum, copper, nickel, cobalt and combinations thereof.

3. The cutting tool insert according to claim 1, wherein the abrasive tip is shaped to carry chips away from the insert body.

4. The cutting tool insert according to claim 1, wherein the abrasive tip is harder than the insert body.

5. The cutting tool insert according to claim 1, wherein the insert body is threadedly connected to the tip.

6. The cutting tool insert according to claim 1 wherein the insert body and included tip define an insert system and wherein the insert system has an overall bulk density greater than five grams per cubic centimeter.

7. The cutting tool insert according to claim 1 wherein the abrasive tip is selected from the group including silicon carbide, silicon nitride, alumina, cubic boron nitride, hexagonal boron nitride, tungsten carbide, and diamond.

8. A method of making a cutting tool insert, comprising:
a) positioning an abrasive tip in a mold;
b) filling the mold with a powder metal mixture;
c) flowing the powder metal mixture around at least a portion of the tip to define a green body;
d) compacting the green body to define a pressed green body;
e) sintering the pressed green body to yield a sintered body having a metallic portion and a tip portion; and
f) cooling the sintered body to put the tip portion into compression;
wherein the tip portion is non-adhesively mechanically attached to the metallic portion.

9. The method of claim 8 wherein the tip portion is shaped to lockingly engage the metallic portion.

10. The method of claim 8 wherein the powder metal mixture is selected from the group including iron, copper, nickel, cobalt and combinations thereof.

11. The method of claim 8 wherein the powder metal mixture includes binders.

12. The method of claim 8 wherein during step a), a plurality of abrasive tips are placed in the mold; and wherein the sintered body has a plurality of tip portions.

13. The method of claim 8 wherein the abrasive tip is selected from the group including cubic boron nitride, hexagonal boron nitride, tungsten carbide, and diamond.

14. A method of making a composite insert, comprising:
a) positioning a powder metal mixture around at least a portion of an abrasive member to define a green body; and
b) solidifying the green body to define a unitary body having a metallic portion and an abrasive portion; and
wherein the abrasive portion is non-adhesively mechanically attached to the metallic portion.

15. The method of claim 14 wherein step b) further comprises:
b1) compacting the green body to define a pressed body;
b2) after b1), sintering the pressed body to yield a sintered body having a metallic portion and an abrasive portion; and
b3) after b2), cooling the sintered body to put the abrasive portion into compression.

16. The method of claim 14 wherein the powder metal mixture is selected from the group including iron, copper, nickel, cobalt and combinations thereof.

17. The method of claim 14 wherein the powder metal mixture includes binders.

18. The method of claim 14 wherein the abrasive tip is selected from the group including cubic boron nitride, hexagonal boron nitride, tungsten carbide, and diamond.

19. The method of claim 14 wherein during a), the powder metal mixture is flowed around at least a portion of each of respective abrasive member of a plurality of abrasive members.
